(19) United States
(12) Patent Application Publication
(10) Pub. No.: US 2015/0135105 A1
(43) Pub. Date: May 14, 2015

(54) INTERACTING WITH AN APPLICATION

(71) Applicant: Samsung Electronics Co., Ltd., Gyeonggi-do (KR)

(72) Inventors: Manish Jain, Uttar Pradish (IN); Shubham Joshi, Uttarakhand (IN); Brij Mohan Purohit, Uttarakhand (IN)

(21) Appl. No.: 14/536,393

(22) Filed: Nov. 7, 2014

(30) Foreign Application Priority Data
Nov. 8, 2013 (IN) 3292/DEL/2013

(51) Int. Cl. G06F 3/0481

(52) U.S. Cl. CPC G06F 3/04817
USPC 715/765

(57) ABSTRACT

The embodiments herein provide a method and system for interacting with an application icon of an electronic device. Further, the method includes associating an interaction of the application icon with an activity to be performed in the application. Furthermore, the method includes executing the activity defined by the interaction without invoking the application.

### PRIORITY

The present application is related to and claims priority under 35 U.S.C. §119(a) to Indian Patent Application Serial No. 3292/DEL/2013 filed in the Indian Intellectual Property Office on Nov. 8, 2013, the entire disclosure of which is incorporated herein by reference.

### TECHNICAL FIELD

The embodiments herein generally relates to application in an electronic device, and more particularly to a mechanism for executing an activity related to an application by interacting with an application icon.

### BACKGROUND

Generally, almost all electronic devices display icons on the graphical user interface for accessing folders, applications, programs and the like. Icons allow users to navigate and access content from the electronic device. Icons can be displayed as per user requirement on the display of the electronic device. They can be edited to change their appearance, location, and the like. On clicking on an icon related to an application, the application is invoked and user can use the application. In some embodiments, the user may navigate through multiple pages to execute a function associated with the application.

Different methods and systems have been proposed to increase the functionality of application icon. One mechanism includes adjusting parameters of an application in an electronic device using graphical objects like knob, switch, pushbuttons and the like. The graphical objects can be responsive to multi-touch gestures from users. The use of the multi-touch gestures and objects allows users to control parameters like volume, zoom, and the like.

In yet another mechanism, the application icon may contain panels which can display updates related to the application. On receiving an update, the application icon is displayed as rotating in three dimensions to display panel containing updates. One application icon may be configured to display updates related to different activities of the application. The three-dimension rotation display different panels containing updates associated with the application icon.

In yet another mechanism, on receiving a first user gesture, application icons with adjustable settings option are displayed with a different appearance than the application icons which do not provide user adjustable settings option. A second user gesture allows users to select the application icon with user adjustable settings option. On selection, the application icon displays settings of the application. The user can make modifications to the settings, save the changes and exit. Once the user exits after modifying settings of the application, all the application icons switch back to a pre-defined display state.

Though the existing systems and methods are effective to a degree in increasing the functionality of an application icon by allowing users to receive updates, change parameters and configure settings of the application, they require users to perform multiple gestures and modify existing user interface. Further, a user traverses multiple levels of user interface pages to set functionality of a desired application.

### SUMMARY

To address the above-discussed deficiencies, it is a primary object to provide a method for interacting with at least one application icon in an electronic device, the method includes identifying an interaction performed on a displayed at least one first application icon by a user. Further the method includes associating at least one activity with the identified interaction on the displayed at least one first application icon. Further, the method includes executing at least one activity associated with the identified interaction.

Accordingly the disclosure provides a system for interacting with at least one application icon in an electronic device. The electronic device is configured to identify an interaction performed on a displayed at least one first application icon by a user. Further, the electronic device is configured to associate at least one activity with the identified interaction on the displayed at least one first application icon using icon activity manager. Further, the electronic device is configured to execute the at least one activity associated with the identified interaction.

Accordingly the disclosure provides an apparatus for interacting with at least one application icon in an electronic device. The apparatus includes an integrated circuit. The integrated circuit includes a processor, and a memory including a computer program code within the circuit. Further, the memory and the computer program code with the processor cause the product to identify an interaction performed on a displayed at least one first application icon by a user. Further, the memory and the computer program code with the processor cause the product to associate at least one activity with the identified interaction on the displayed at least one first application icon. Further, the memory and the computer program code with the processor cause the product to execute at least one activity associated with the identified interaction.

Accordingly, the disclosure provides a non-transitory machine-readable medium carrying one or more instructions which, when executed by one or more processors, cause the one or more processors to identify an interaction performed on a displayed at least one first application icon by a user. Further, the instructions further cause the processors to associate at least one activity with the identified interaction on the displayed at least one first application icon using icon activity manager. Further, the instructions further cause the processors to execute the at least one activity associated with the identified interaction.

These and other aspects of the embodiments herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagram of, among other things, a high level overview of a system, according to embodiments disclosed herein;

FIG. 2 illustrates a block diagram showing different modules involved in recording and updating activity associated with an application icon displayed in the electronic device, according to embodiments disclosed herein;

FIG. 3 illustrates a process of a method for interacting with the first application icon, according to embodiments disclosed herein;

FIG. 4 illustrates a process of an alternate method for interacting with the first application icon, according to embodiments disclosed herein;

FIG. 5 illustrates a block diagram showing an activity life cycle of the second application icon, according to embodiments disclosed herein;

FIG. 6 illustrates an example of interacting with a message application icon by changing the orientation, according to embodiments disclosed herein;

FIG. 7 illustrates an example of interacting with a multimedia application icon by changing the orientation, according to embodiments disclosed herein;

FIG. 8 illustrates another example of interacting with the multimedia application icon by changing the orientation, according to embodiments disclosed herein;

FIG. 9 illustrates an example of interacting with a clock application icon by changing the orientation of the clock application icon for setting up an alarm, according to embodiments disclosed herein;

FIG. 10 illustrates an example of interacting with a stop watch application icon by changing the orientation of the stop watch application icon to start and pause the activity associated with the stop watch application icon, according to embodiments disclosed herein;

FIG. 11 illustrates an example of changing activities associated with the multimedia application icon, according to embodiments disclosed herein;

FIG. 12 illustrates an example of changing activities associated with a call application icon, according to embodiments disclosed herein;

FIG. 13 illustrates an application activity stack, according to the embodiments disclosed herein;

FIG. 14 illustrates a process of a method for managing one or more activities in the second application icon, according to embodiments disclosed herein;

FIG. 15 illustrates an application activity stack, managing activities in multiple application icons, according to the embodiments disclosed herein; and

FIG. 16 illustrates a computing environment implementing the method of interacting with an application icon in an electronic device, in accordance with various embodiments of the present disclosure.

### DETAILED DESCRIPTION

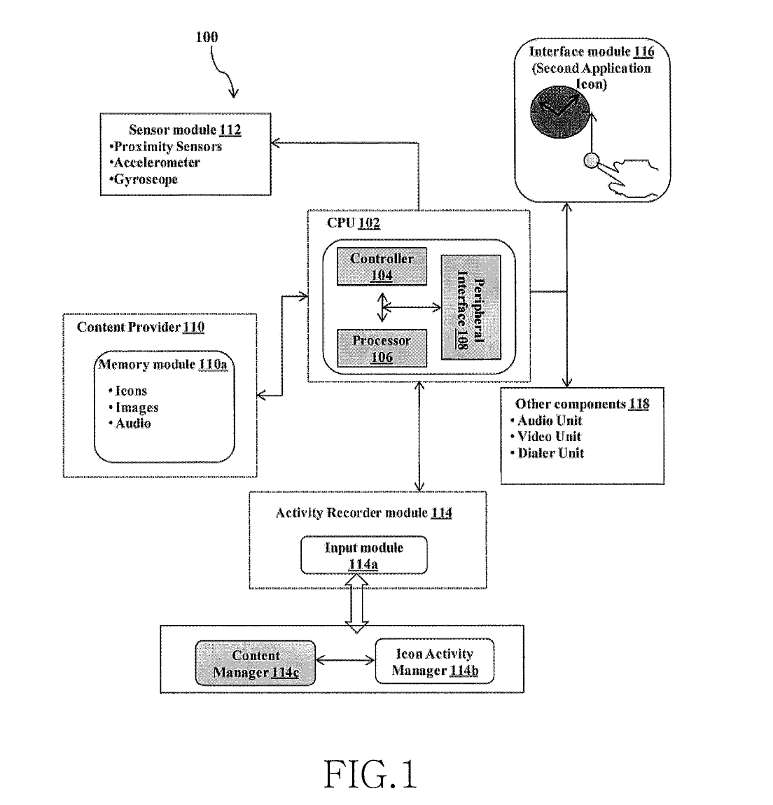

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system and method. The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein achieve a method and system for interacting with one or more application icons in an electronic device. The method includes displaying one or more application icons to the user and allows the user to interact with one or more application icons.

In an embodiment, the interaction can be changing orientation of one or more application icons.

Throughout the document, the terms interaction and orientation change are used interchangeably.

Further, the method identifies the orientation change of one or more application icons and executes an activity associated with the corresponding application based on the identified orientation change. The application icon on which user performs the orientation change (first application icon) gets converted to a second application icon displaying the activity associated with the identified orientation. For example, the first application icon can be termed as a normal icon and the second application icon can be termed as a smart icon.

Throughout the document, the terms smart icon and second application icon are used interchangeably.

The method and system disclosed herein is simple, dynamic, robust, and reliable for allowing the user to configure the application activity without having to navigate through different layers of the application. The proposed method and system executes an activity by identifying the orientation change of the application icon without invoking the application.

Referring now to the drawings, and more particularly to FIGS. 1 through 16, where similar reference characters denote corresponding features consistently throughout the figures, there are shown one or more embodiments.

FIG. 1 illustrating generally, among other things, a high level overview of a system 100, according to embodiments as disclosed herein. In an embodiment, the system 100 can be configured to include the following modules in the electronic device: A CPU 102, further the CPU comprises a controller 104, a processor 106, and a peripheral interface 108. Further, the CPU 102 is connected to a content provider 110. In an embodiment, the content provider 110 comprises of: a memory module 110a that stores one or more second icons for displaying on the electronic device, one or more image files, one or more audio files and the like. The content provider 110 is configured to communicate the used data to the Interface module 116 displaying the second icon. Further, the content provider 110 interacts with the content manager 114c. The content manager 114c is configured to access the content provider's 110 database for obtaining content such as image files, audio files, icon files and the like as used by the content manager 114c.

The system 100 further comprises a Sensor module 112, an Activity recorder module 114, an Interface module 116, and other components module 118. In an embodiment, the Activity recorder module 114 comprises an input module 114a which communicates with an icon activity manager 114b and the content manager 114c.

In an embodiment, the interface module 116 displays the interactive application icons.

The electronic device described herein can be for example, but not limited to, Smartphone, tablet, laptop, computer, wired devices, wireless devices, communicator, portable electronic device, wearable computing devices, flexible devices, electronic kiosk, and the like. In an embodiment, the electronic device can include a touch surface which senses touch from user fingers into electrical signals and delivers the signals to the electronic device or a non-touch screen that can send inputs by pressing a button, a joy stick, or the like.

In an embodiment, a central processing unit (CPU) module 102, also referred to as a central processor unit is a circuitry necessary to interpret and execute application program instructions in the electronic device by performing the basic arithmetical, logical, and input/output operations.

In an embodiment, the Interface unit module 116 can be configured to receive an action from a user to change orientation of one or more application icons on the electronic device.

In an embodiment, the action from the user can be initiated through a gesture, a joy-stick, a key-board, touch and the like.

In an embodiment, examples of gesture include but not limited to swiping, rotating, dragging, hovering and the like from a user finger or a stylus performed on the application icon.

In an embodiment, a first icon depicts the application displayed on electronic device before the orientation change is identified.

In an embodiment, as one or more application icons change its orientation on the electronic device, one or more application icons display a second icon.

In an embodiment, the second icon depicts that user performs an orientation change which is associated with an activity of the second application icon. Further, as the second icon is displayed on the electronic device, the method allows the Interface module 116 to communicate with the content provider 110.

Throughout the document, the terms first icon and first application icon are used interchangeably.

Throughout the document, the terms second icon and second application icon are used interchangeably.

Throughout the document, the terms Icon Activity Manager and Activity Manager are used interchangeably.

In an embodiment, the CPU module 102 is configured to interact with the sensor module 112 supported in the electronic device. The sensor module 112 is configured to support various types of sensors such as: a proximity sensor, an accelerometer, a gyroscope and the like. The CPU module 102 invokes the sensors for performing any action.

In an embodiment, the activity recorder module 114 is configured to continuously record the activity associated with the orientation change of one or more applications.

In one embodiment, the activity recorder module 114 commits the recorded actions after the user changes the display of the second icon to the first icon by changing the orientation of the application icon. The activity recorder module 114 is configured to fetch the data and updates the data intended for the second application icon through the Input module 114a.

Further, the activity recorder module 114 uses the Icon Activity Manager module 114b to invoke the activity corresponding to the orientation of the second application icon.

In an embodiment, the other components module 118 is configured to interact with the Interface unit module 116. When the user changes the orientation of the first application icon on the electronic device, the first application icon invokes the activity based on the orientation change. Further, the invoked activity may communicate with other components 118.

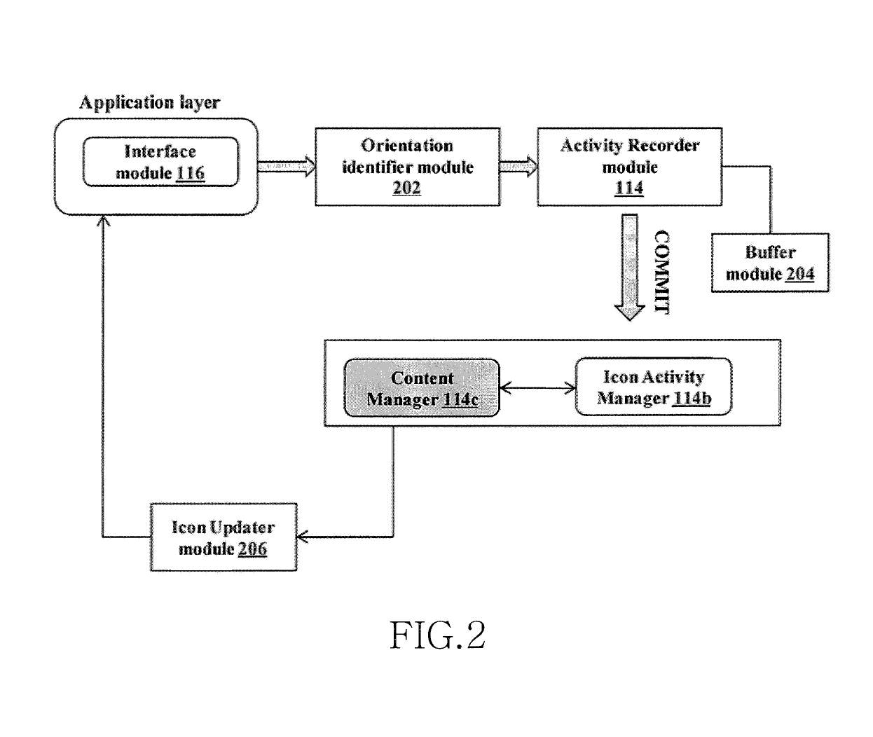

FIG. 2 illustrates a block diagram showing different modules involved in recording and updating activity associated with a second application icon displayed in the electronic device, according to embodiments disclosed herein. In an embodiment, the system 100 can be configured to include the interface module 116, an orientation identifier module 202, an activity recorder module 114, a buffer module 204, the content manager module 114c, the Icon activity manager 114b, and an icon updater module 206. The Interface module 116 is configured to receive an input from the user to change the orientation of one or more application icons displayed on the electronic device. In an embodiment, when user changes the orientation of the first application icon displayed on the user interface module, the second application icon will be initiated.

In an embodiment, the interface module 116 can display one or more first application icons on which the user can perform the orientation change.

In an embodiment, the orientation identifier module 202 is configured to identify the orientation change in the displayed first application icon. As the orientation of the first application icon changes, the activity recorder module 114 is configured to record one or more activities associated with the first application icon.

In another embodiment, the orientation change for the application icon can be provided as an input to the orientation identifier module 202.

In an embodiment, the buffer module 204 is used to store the recorded activity data until a commit is initiated for the activity associated with the second application icon. For example, the buffer module 204 stores the time data until the user provides a commit for setting the alarm timing.

In an embodiment, the recorded activities of the first application icon are stored in the buffer module 204. The buffer module 204 is configured to record the activities continuously until the user initiates a commit request.

In an embodiment, the commit request can be initiated by the user in one of the following ways: selecting a button on the interface module 116, sending a commit request, initiating a recording activity for other application icons on the electronic device.

In another embodiment, the commit request can be initiated automatically based on the orientation change identified by the orientation identifier module 202.

In an embodiment, as the user initiates the commit request for the recorded activity, the content manager module 114c is configured to store the recorded activity for the second application icon in the form of a stack. In an embodiment, the content manager module 114c is configured to manage the recorded activities of first application icon based on the orientation change identified by the orientation identifier module 202. Further, the content manager module 114c is configured to interact with the Icon activity manager module 114b and the Icon updater module 206. The Icon activity manager module 114b is configured to associate the activity with the identified orientation change performed on the first application icon and the Icon updater module 206 converts the first application icon to the second application icon.

The Icon activity manager module 114b is configured to interact with the content manager module 114c to get or set the recorded activity using the existing methods such as a getter method or a setter method. Further, the Icon activity manager module 114b interacts with the Icon updater module 206 to provide the used data to the Icon updater module 206. Additionally, the Icon activity manager module 114b can be used to invoke multiple levels of the application on the electronic device.

In an embodiment, the Icon activity manager module 114b uses a configuration file to execute the following activities by reading the configuration file: setting the recorded activity, invoking the application from any level based on the application icon activity performed on the electronic device, sharing the used data with the Icon updater module 206. For example, the configuration file can include instruction to set the alarm time on the electronic device that is read by the Icon activity manager module 114b. In an embodiment, the configuration file may be stored in a storage device locally at the electronic device or at a remote storage location (such as online database). Further, the configuration file may be dynamically modified to include any modifications for ease of functionality of the present disclosure. In an embodiment, the configuration file may be dynamically configured to assign user defined activities corresponding to recorded interactions with application icons.

In an embodiment, the Icon updater module 206 is configured to convert the first application icon to the second application icon and vice-versa.

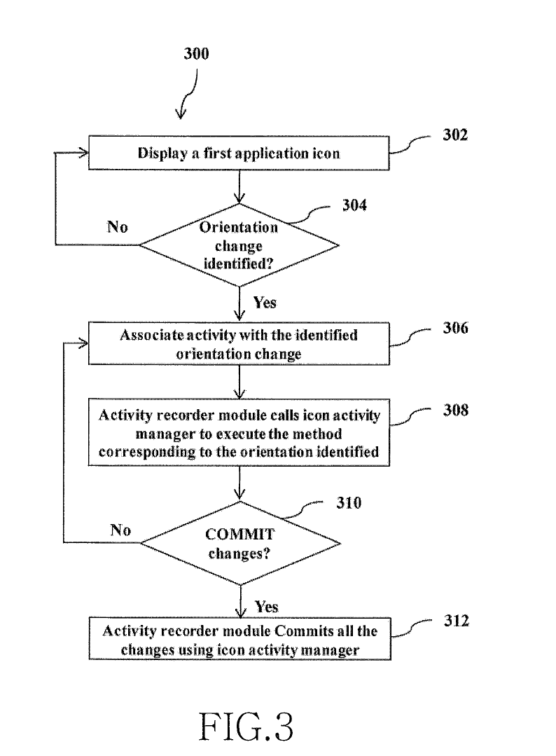

FIG. 3 illustrates a process of a method 300 for interacting with the first application icon, according to embodiments as disclosed herein. The method 300 and other description described herein provide a basis for a control program, which can be implemented using a microcontroller, microprocessor, or an equivalent thereof. In an embodiment, at block 302, the method 300 includes displaying the first application icon. The first application icon can be any application icon displayed on the interface module 116. In an embodiment, at block 304, the method includes identifying any changes in the orientation of the first application icon. The orientation identifier module 202 is configured to identify the changes in the orientation of the first application icon.

In an embodiment, at block 306, the method includes associating an activity with the identified orientation change. The activity recorder module 114 is configured to interact with the icon activity manager 114b to associate the orientation change of the first application icon with the activity of the application.

On identification of activity associated with orientation change, the activity recorder module 114 is configured to record all the orientation changes performed by the user on the application icon. Till the user commits the first application icon the activity recorder module 114 is configured to record changes continuously.

In an embodiment, at block 308, the method includes recording changes in orientation of the first application icon. The activity recorder module 114 is configured to record the orientation changes in the first application icon. In an embodiment, the activity recorder module 114 is configured to record orientation changes in multiple first application icons in the electronic device. Consider an example, when the user changes the orientation of a music player application to listen to music and sets an alarm by changing the orientation of a clock application icon.

In an embodiment at block 308, the method includes executing a method corresponding to the identified orientation change. The activity recorder module 114 uses an Icon Activity Manager module 112b to execute the activity associated with the orientation of the first application icon.

In an embodiment, at block 310, the method includes checking for COMMIT changes. In an embodiment, once the activity associated with the first application icon is completed the activity is considered committed. An activity can also be committed by the user through an action, such as a gesture, change in orientation, executing the ‘back’ operation and the like.

In an embodiment, at block 312, the method includes committing all the changes, on receiving a commit at the activity recorder module 114. The activity recorder module 114 is configured to disable the activity initiated in the first application icon.

Although the above method is described for interacting with one first application icon, it should be understood that user can interact with multiple first application icons present on the display of the electronic device and invoke activities in multiple first application icons. The various steps, blocks, operations, and acts described with respect to the FIG. 3 can be performed in sequential order, in random order, simultaneously, parallel, or a combination thereof. Further, in some embodiments, some of the steps, blocks, operations, and acts can be omitted, skipped, modified, or added without departing from scope of the disclosure.

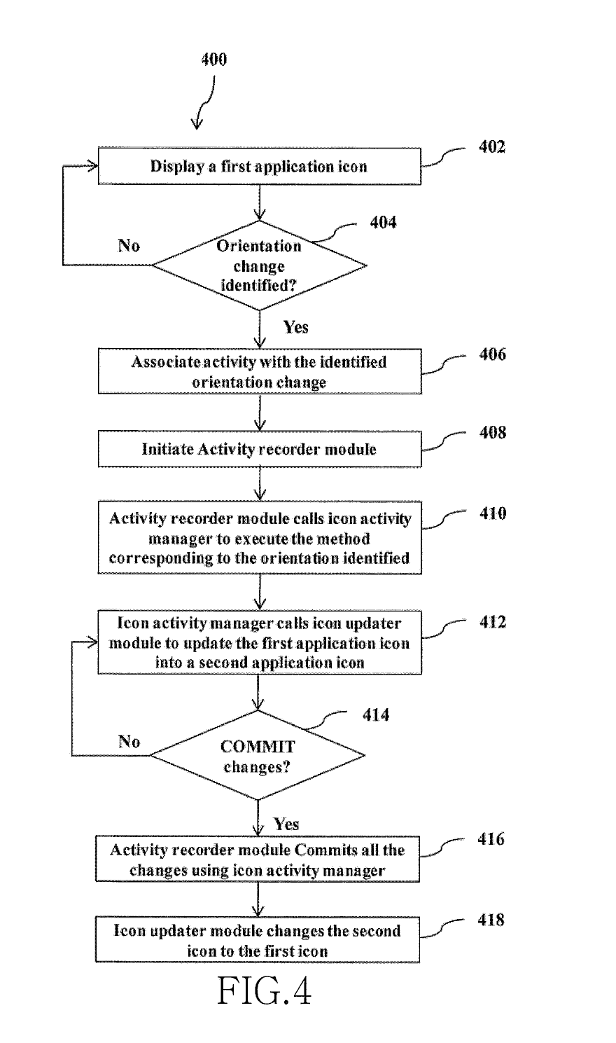

FIG. 4 illustrates a process of an alternate method 400 for interacting with the first application icon, according to embodiments as disclosed herein. The method 400 and other description described herein provide a basis for a control program, which can be implemented using a microcontroller, microprocessor, or an equivalent thereof. In an embodiment, at block 402, the method 400 includes displaying the first application icon. The first application can be any application icon displayed on the interface module 116. In an embodiment, at block 404, the method includes identifying any changes in the orientation of the first application icon. The orientation identifier module 202 is configured to identify the changes in the orientation of the first application icon.

In an embodiment, at block 406, the method includes associating an activity with the identified orientation change. The activity recorder module 114 interacts with the icon activity manager 114b to associate the orientation change of the first application icon with an activity of the application.

In an embodiment, at block 408, the method includes initializing the activity recorder module 114. The activity recorder module 114 is configured to record all the orientation changes done by the user on the application icon (both first and second). Till the user commits the second application icon the activity recorder module continues recording changes. In an embodiment, at block 410, the method includes recording changes in orientation of the first application icon. The activity recorder module 112 is configured to record the orientation changes in the first application icon. In an embodiment, the activity recorder module is configured to record orientation changes in multiple first application icons in the electronic device. Consider an example, when the user changes the orientation of a music player application to listen to music and sets an alarm by changing the orientation of a clock application icon.

In an embodiment at block 410, the method includes executing a method corresponding to the orientation identified. The activity recorder module 114 uses an Icon Activity Manager module 112b to execute an activity corresponding to the orientation of the application icon.

In an embodiment, at block 412, the method includes displaying a second application icon based on the orientation change. The icon updater module 22 is called upon by the icon activity manager 114b for changing the first application icon into second application icon. The appearance of the first application icon is modified to display the second application icon using an icon updater module 206. The second application icon is configured to indicate activity associated by the orientation change. Consider an example, when the orientation of a music player icon (first application icon) is changed to play music from the playlist. The music player icon (second application icon) includes a headset indicating that an activity is being performed.

In an embodiment, at block 414, the method includes checking for COMMIT changes. In an embodiment, once the activity associated with the second application icon is completed the activity is considered committed. An activity can also be committed by the user through an action such as a gesture, change in orientation, executing the back operation and the like.

In an embodiment, at block 416 the method includes committing all the changes, on receiving commit request at the activity recorder module 114. The activity recorder module 114 is configured to disable the activity initiated in the second application icon.

In at embodiment, at block 418, the method includes changing the second application icon into the first application icon. The icon updater module 206 is configured to change the second application icon into the first application icon. The change back to the first application icon indicates that the activity initiated based on the orientation that has been committed.

Although the above method is described for interacting with one first application icon, it should be understood that user can interact with multiple first application icons present on the display of the electronic device and invoke activities in multiple first application icons. The various steps, blocks, operations, and acts described with respect to the FIG. 4 can be performed in sequential order, in random order, simultaneously, parallel, or a combination thereof. Further, in some embodiments, some of the steps, blocks, operations, and acts can be omitted, skipped, modified, or added without departing from scope of the disclosure.

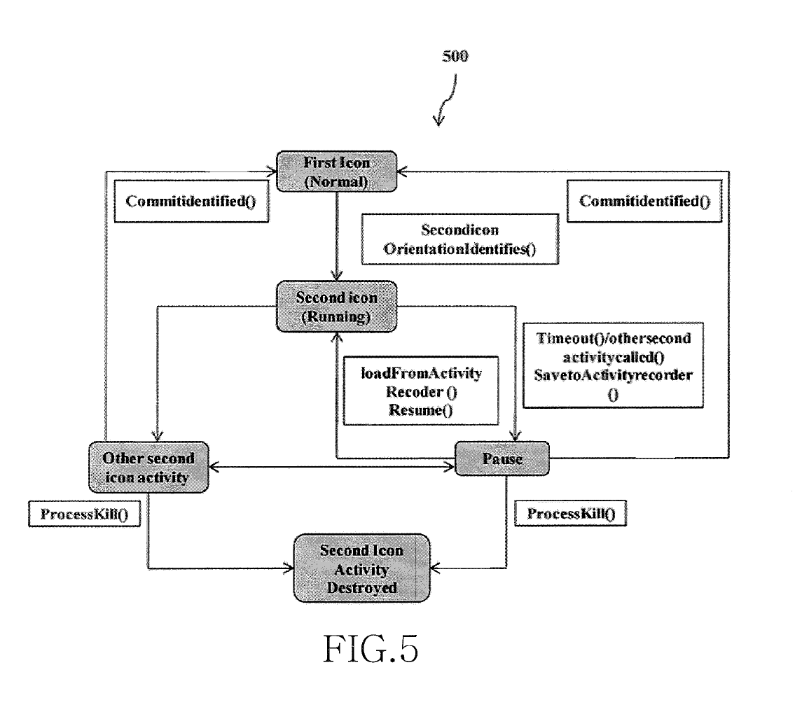

FIG. 5 illustrates a block diagram showing an activity life cycle of a second application icon, according to embodiments as disclosed herein. As shown in figure the activity life cycle 500 of a second application consist of a normal state, a running state, a pause state and a destroyed state. The first application icon is considered to be normal state till activity is not initiated. When the first application icon changes into second application icon based on the orientation change provided by user, the second application icon is considered to be in a running state. An activity related to the second application icon is invoked. The second application icon enters into a pause state if a timeout occurs or if an activity associated with another second application is initiated. When the second application icon enters into pause mode, the current state of the second application icon is saved in the activity recorder module 114. Once the activity associated with another second application is committed, the second application icon may move from pause state to running state. Any time an activity is committed, the second application icon is considered to be in destroyed state. Once the second application is committed, the first application comes back into normal state.

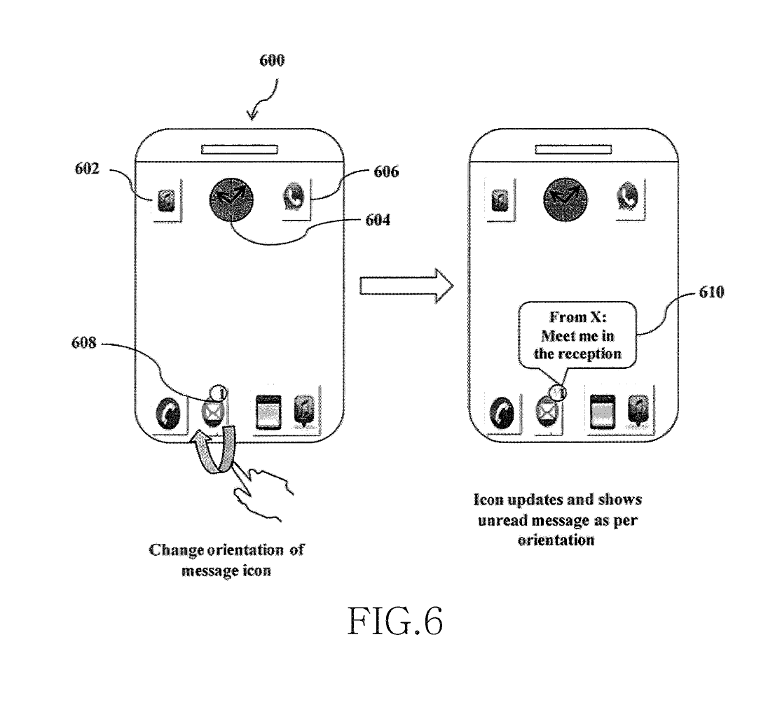

FIG. 6 illustrates an example of interacting with a message application icon by changing the orientation, according to embodiments disclosed herein. In an embodiment, the electronic device 600 is configured to display the first application icons such as a music player 602, a clock 604, an instant message 606 and a messaging application 608. Further, the user changes the orientation of the messaging application icon 608 by performing a clockwise rotation of the messaging application icon 608. Upon changing the orientation of the messaging application icon 608, the Icon Activity module 114b is configured to execute the activity recorded for the messaging application icon 608. For example, the user changes the orientation of the messaging application icon 608 by performing the clockwise rotation on the messaging application icon 608. Upon changing the orientation of the messaging application icon 608, the messaging application icon starts displaying unread messages (610) to the user based on the orientation of the messaging application icon 606. The Icon Activity module 114b is configured to display unread messages (610) to the user on the messaging application icon 608. Further, the Icon activity module 114b is configured to deactivate from displaying unread messages on the messaging application icon 608 after the user performs an anticlockwise rotation of the messaging application icon 608.

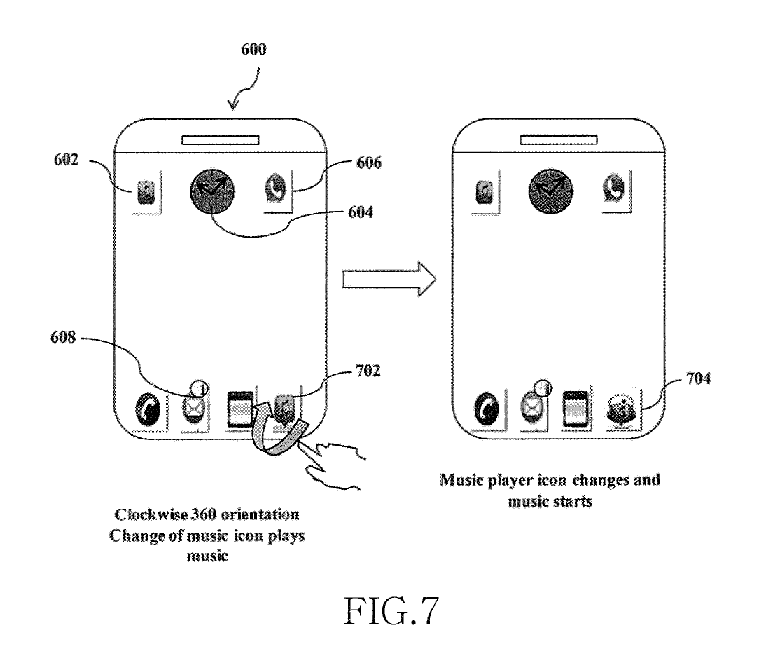

FIG. 7 illustrates an example of interacting with the multimedia application icon by changing the orientation, according to embodiments disclosed herein. In an embodiment, the electronic device 600 is configured to display the first application icons such as music player 602, clock 604, instant message 606 and a multimedia application icon 702. Further, the user changes the orientation of the multimedia application icon 702 by performing a clockwise 360 degree rotation on the multimedia application icon 702. Upon changing the orientation of the multimedia application icon 702, the orientation identifier module 202 is configured to identify the change in orientation of the multimedia application icon 702, and the Icon activity manager module 114b is configured to execute the activity recorded for the multimedia application icon 702. Further, the Icon updater module 206 changes the first multimedia application icon 702 to the second multimedia application icon 704 as shown in the figure. The Icon activity manager module 114b is configured to play recorded songs on the electronic device 600.

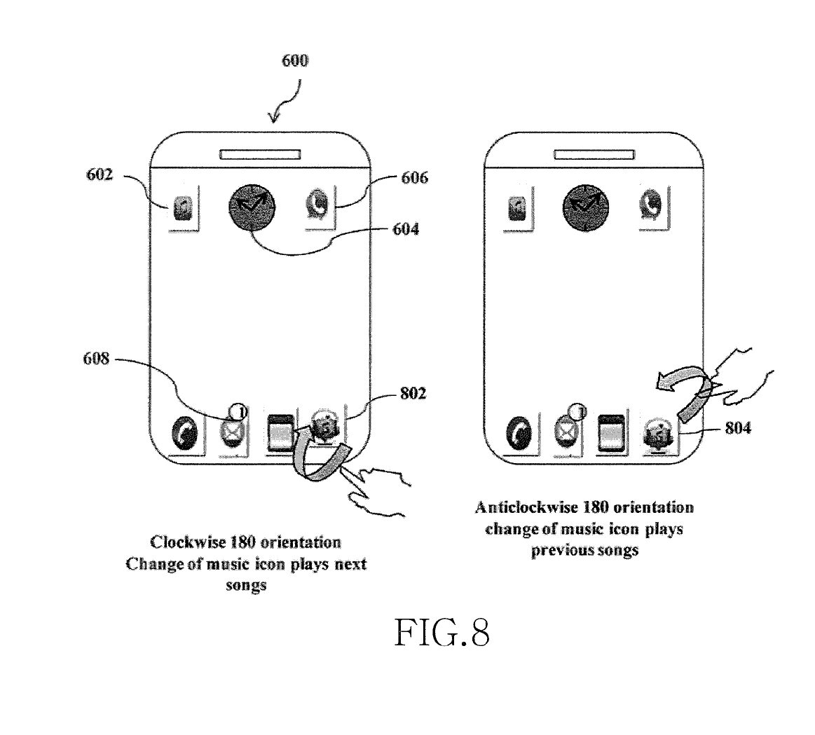

FIG. 8 illustrates another example of interacting with multimedia application icon by changing the orientation, according to embodiments disclosed herein. In an embodiment, the electronic device 600 is configured to display the first application icons such as music player 602, clock 604, instant message 606 and a multimedia application icon 802. In an embodiment, the user changes the orientation of the multimedia application icon 802 by performing a clockwise 180 degree rotation of the multimedia application icon 802. The orientation identifier module 202 is configured to identify the orientation change on the multimedia application icon 802 and the Icon activity manager module 114b is configured to execute the activity recorded for the multimedia application icon 802.

Further, the user changes the orientation of the multimedia application icon 802 by performing an anticlockwise 180 degree rotation. As shown in the figure, the display of the multimedia application icon 802 is changed to multimedia application icon 804 after the anticlockwise orientation is identified by the orientation identifier module 202.The Icon activity manager module 114b is configured to execute a different activity recorded for the multimedia application icon 804. Further, the icon activity manager module 114b starts playing recorded songs stored on the electronic device 600.

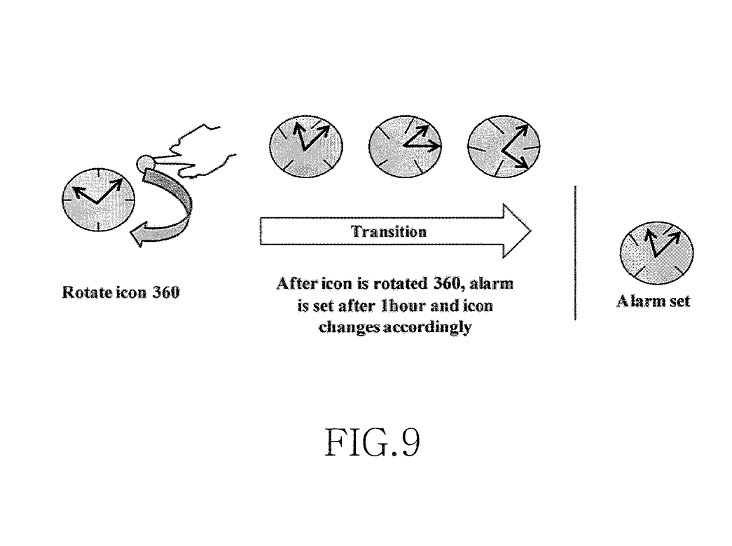

FIG. 9 illustrates an example of interacting with a clock application icon by changing the orientation of the clock application icon for setting up an alarm, according to embodiments disclosed herein. As illustrated in the example, a clock application icon is displayed on the electronic device 600. Further, the user changes the orientation of the clock application icon by performing a clockwise 360 degree rotation on the clock application icon. In an embodiment, the orientation identifier module is configured to identify the orientation change, and the clock application icon sets alarm based on the orientation change.

Further, the user changes the orientation of the clock application icon by performing another clockwise 360 degree rotation on the clock application icon. Upon changing the orientation on the clock application icon, the clock application icon updates the recorded alarm timing by an hour using the activity recorder module 114. In an embodiment, the user can reset the alarm by performing anticlockwise 360 degree rotation on the clock application icon using the activity recorder module 114.

As shown in the figure, during the transition phase (as the user changes the orientation of the clock application icon in steps), the second application icon is updated for every orientation change using the Icon updater module 206.

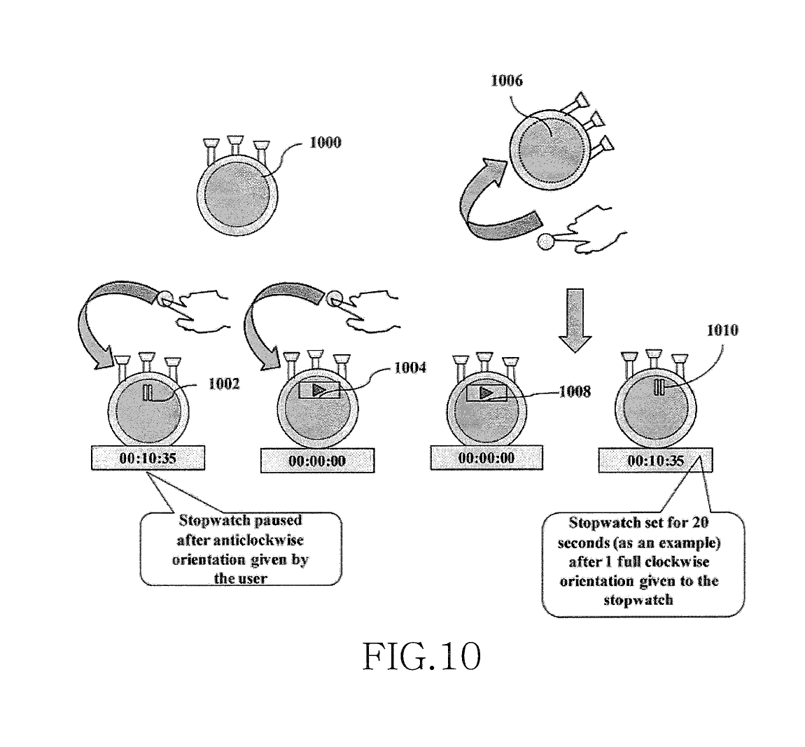

FIG. 10 illustrates an example of interacting with a stop watch application icon by changing the orientation of the stop watch application icon to start and pause the activity associated with the stop watch application icon, according to embodiments disclosed herein. As illustrated in the example, a stopwatch application icon 1000 is displayed on the electronic device 600. In an embodiment, the user changes the orientation of the stopwatch application icon 1000 by performing an anticlockwise 360 degree rotation on the stopwatch application icon. Upon changing the orientation of the application icon 1000, the stopwatch application icon 1000 pauses (1002) at the elapsed time 10 minutes and 35 seconds. Further, as the user changes the orientation of the stopwatch application icon 1000 by performing another anticlockwise 360 degree rotation, the time is reset (1004) on the stopwatch application icon 1000 using the Icon activity manager module 114b. Further, the user changes the orientation (1006) of the stopwatch application icon by performing a clockwise 360 degree rotation on the stopwatch application 1000. Upon changing the orientation of the stopwatch application icon 1000, identified by the orientation identifier module 202, the stopwatch application icon 1006 starts (1008) the stopwatch clock from the reset time. Further, as the user changes the orientation of the stopwatch application icon 1006 by performing another clockwise 360 degree rotation, the elapsed time 10 minutes and 35 seconds is paused (1010) on the stopwatch application icon 1000 using the icon activity manager module 114b.

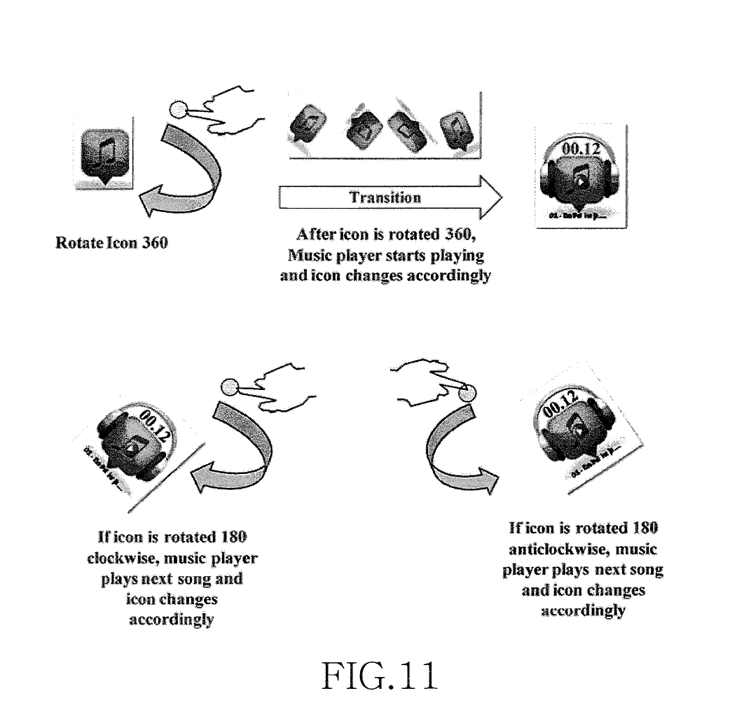

FIG. 11 illustrates an example of changing activities associated with the multimedia application icon, according to embodiments disclosed herein. As illustrated in the figure, the user changes the orientation of the multimedia application icon (first application icon) by performing a clockwise 360 degree rotation on the multimedia application icon. Upon changing the orientation of the multimedia application icon as identified by the orientation identifier module 202, the multimedia application icon starts executing the activity recorded for the multimedia application icon using the Icon activity manager module 114b. Further, the user changes the orientation of the application icon by performing an anticlockwise 180 degree rotation of the application icon. Upon changing the orientation of the application icon in the anticlockwise direction as identified by the orientation identifier module 202, the application icon starts executing a different activity recorded (using the Icon activity manager module 114b) and the change in multimedia application icon is displayed to the user. For example, the user changes the orientation of the multimedia application icon by performing a clockwise 180 degree rotation. Upon changing the orientation of the multimedia application icon, the multimedia application icon starts playing recorded songs in a particular sequence stored on the electronic device 600 using the activity recorder module 114. As a next step, the user changes the orientation of the multimedia application icon by performing an anticlockwise 180 degree rotation on the multimedia application icon. Upon changing the orientation of the multimedia application icon in the anticlockwise direction as identified by the orientation identifier module 202, the multimedia application icon starts playing the next song stored on the electronic device 600.

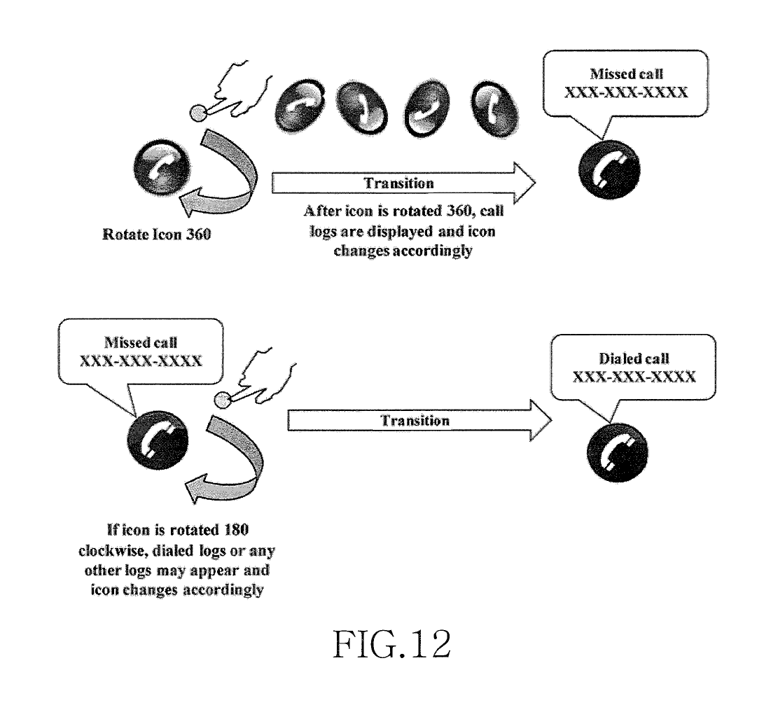

FIG. 12 illustrates an example of changing activities associated with a call application icon, according to embodiments disclosed herein. As illustrated in the example, the user changes the orientation of the call application icon by performing a clockwise 360 degree rotation of the call application icon. Upon changing the orientation of the call application icon as identified by the orientation identifier module 202, the call application icon starts executing the activity recorded for the second call application icon using the icon activity manager module 114b, and the change in call application icon is displayed to the user. The activity that is associated with the orientation change is displaying a missed call number.

Further, the user changes the orientation of the call application icon by performing a clockwise 180 degree rotation of the call application icon. Upon changing the orientation of the call application icon by performing the specified rotation as identified by the orientation identifier module 202, the call application icon starts executing another activity using the icon activity manager module 114b. Another activity associated with the clockwise 180 degree rotation is displaying dialed call details to the user.

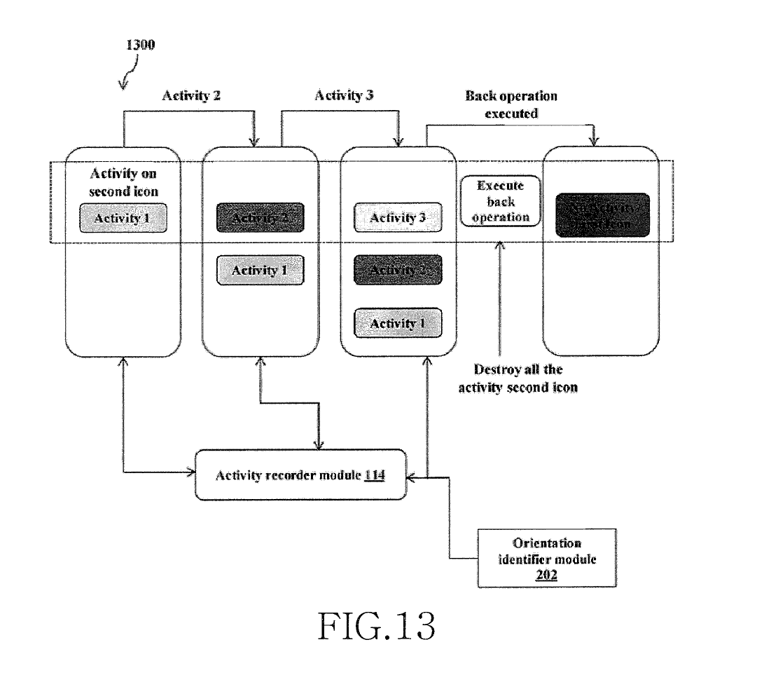

FIG. 13 illustrates an application activity stack 1300, according to the embodiments disclosed herein. The figure shows a stack including all the activities related to the second application icon. The activity recorder module 114 is configured to place the most recent (latest) activity initiated at the top of stock. Based on the orientation change performed on the second application icon, the activity recorder module 114 and the orientation identifier module 202 is configured to associate an activity with the identified orientation and record changes to the second application icon. Based on the orientation changes done by user, each orientation change can be associated with each activity of the application. FIG. 13 shows all the activities related to a single second application icon. In an embodiment, the recent activity is always present at the top of stack.

Consider an example where an activity 1 corresponds to playing a song from a pre-defined playlist in a music player, an activity 2 corresponds to changing next song in the playlist of the music player and an activity 3 corresponds to play from beginning of the song. Each activity associated with the music player described above is user configurable. The user can make orientation changes to the music player application icon and execute different activities.

When a user makes an orientation change to execute activity 1, a method corresponding to the identified orientation change is initiated in the second application. When the user initiates another activity 2 by changing the orientation of the second application icon, a second method corresponding to the identified orientation is initiated in the second application. The orientation identifier module 202 is configured to identify the orientation change and the activity recorder module 114 is configured to record the activity being initiated. The activity 2 related to changing next song in the playlist of the music player is pushed to the top of the stack and the activity 1 related to playing the song is moved to a pause state. When the user initiates activity 3 related to playing the song from the beginning in the music player in the same second application icon, a third method corresponding to the identified orientation change is initiated. The activity 3 is at the top of the stock, followed by activity 2 and activity 1. Activity 3 is executed first, followed by activity 2 and activity 1. As soon as activity 3 is performed and completed, activity 2 is pushed to the top of stack and executed. Once activity 3 related to listening to the song from the beginning is executed, the activity 2 related to changing next song is pushed to top of the stack and executed. Once activity 2 is executed, activity 1 comes to the top of the stack and the music player starts playing the song. In an embodiment, the user can destroy all the activities related to a second application icon by executing the back operation on the electronic device. All the activities initiated by the user are disabled and the second application icon converts back to first application icon.

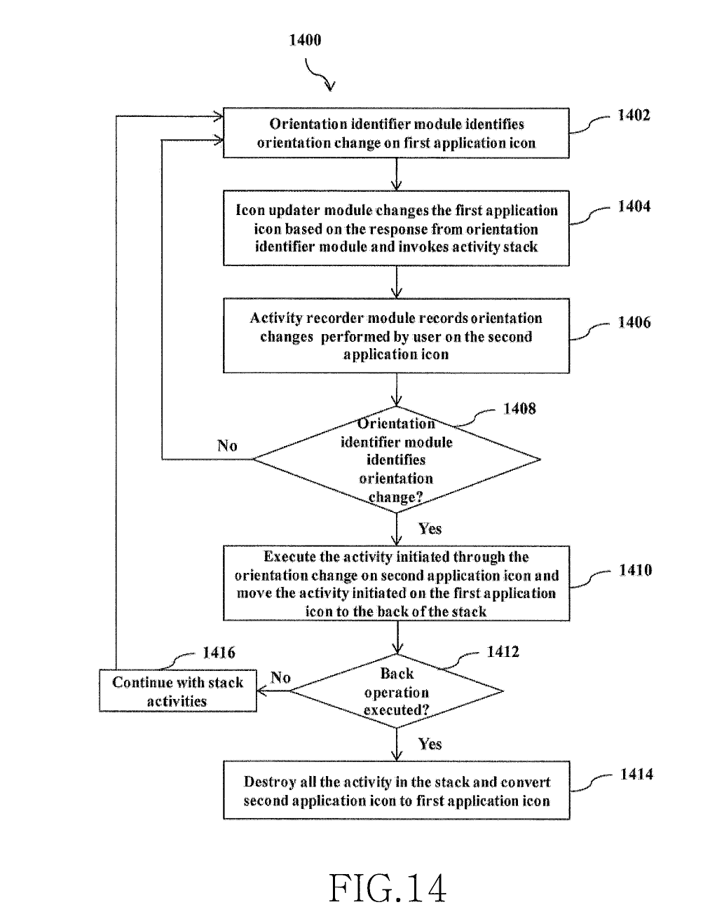

FIG. 14 illustrates a process of a method 1400 for managing one or more activities in the application icon, according to embodiments disclosed herein. The method 1400 and other description described herein provide a basis for a control program which can be implemented using a microcontroller, microprocessor, or an equivalent thereof. In an embodiment, at block 1402, the method includes identifying orientation change on the first application icon. The orientation identifier module 202 is configured to recognize changes in the first application icon. The activity recorder module 114 interacts with the icon activity manager 114b to associate the orientation change of the first application icon with an activity of the first application.

In an embodiment at block 1404, the method includes changing the first application icon into the second application icon based on the orientation change identified in the first application icon using the orientation identifier module 202 and executing a method corresponding to the identified orientation. The activity recorder module 114 uses an Icon Activity Manager module 112b to execute an activity corresponding to the orientation of the first application icon. Once an activity is initiated, an activity stack is invoked in the activity recorder module 114. The appearance of the first application icon is modified to display the second application icon using an icon updater module 206. The second application icon is configured to indicate activity associated by the orientation change. Consider an example of a messaging application icon, where the user changes the orientation to receive messages on the application icon itself. The messaging application icon now contains a message box on top of the messaging icon. This messaging icon is considered as second application icon. On receipt of a message, the message can be displayed in the message box. Now, the user can see the message application and read the received message without invoking the message application on the display of the electronic device 600.

In an embodiment, at block 1406, the method includes recording orientation change in the second application icon. The activity recorder module 114 is configured to start recording any orientation change performed by the user on the second application icon after the icon activity manager 114b invokes the activity associated with the identified orientation change.

In an embodiment, at block 1408, the method includes identifying the orientation change in the second application icon. Once an activity associated with an orientation change is initiated in the second application icon, the activity recorder module 114 is configured to record the activity associated with the second application icon. The activity recorder module 114 is configured to maintain a stack containing all the activities related to the second application icon. In an embodiment, if there are no changes in orientation of application icon, the orientation identifier module 202 continues looking for changes in orientation of the application.

In an embodiment, one or more activities can be associated with the second application icon. Consider an example of a phone application, where some of the activities, which the user can configure, can include missed calls, received calls, dialed calls and the like.

In an embodiment, at block 1410, the method includes executing an activity based on the identified orientation change on the second application icon. When an orientation change is identified in the second application icon, t the icon activity manager module 114b is configured to execute the activity initiated through the orientation change on the second application icon and move the activity initiated on the first application icon to the back of the stack.

The activity recorder module 114 pushes the activity being currently executed in the background and executes the activity associated with the present orientation change on the second application icon. In an embodiment, the activity in the background moves into the pause state.

The activity recorder module 114 is configured to move the most recently invoked activity related to the second application icon on top of the stack.

In an embodiment, at block 1412, the method includes checking if the user executes the back operation. On viewing the result of the activity associated with orientation change in the second application icon, the user can execute the back operation on the electronic device to exit from all activities related to the second application icon.

In an embodiment, at block 1414, all the activities related to a second application icon present in the stack is destroyed and the second application converts back to first application icon. The activity recorder module 114 is configured to destroy activities when a commit is identified for the activity. The icon updater module 206 is configured to change the second application icon into the first application icon. The change back to the first application icon indicates that the activity initiated based on the orientation that has been committed.

In an embodiment, at block 1416, the method includes continuing with the activities present in stack of the activity recorder module 114 when the user does not execute the back operation.

Consider an example, of phone application, where the user has changed the orientation of the phone application icon to view missed calls. When the user changes the orientation of the phone application, to view received calls, the activity related to missed calls is moved to the back of the stack and the activity related to the received calls is moved to top of stack. After viewing the received calls, all the activities related to the phone application icon are killed if the user executes the back operation. If the user views the received call and does not execute the back operation, the other activity (missed call) continues its operation. For example, the user can kill activity by a swipe gesture on the phone application icon. In another example, the user can execute the back operation and kill all the activities being executed in the phone application icon.

Although the above method 1400 is described for managing activities in an application icon, it should be understood that user can interact with multiple application present on the display of the electronic device and invoke activities in multiple application icons. The various steps, blocks, operations, and acts described with respect to the FIG. 14 can be performed in sequential order, in random order, simultaneously, parallel, or a combination thereof. Further, in some embodiments, some of the steps, blocks, operations, and acts can be omitted, skipped, modified, or added without departing from scope of the disclosure.

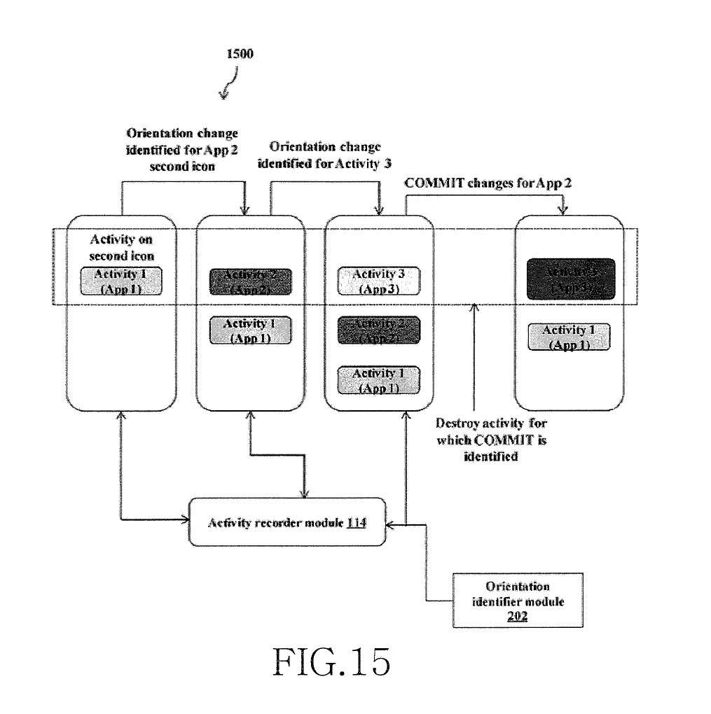

FIG. 15 illustrates an application activity stack 1500, managing activities in multiple application icons, according to the embodiments disclosed herein. The activity recorder module 114 is configured to place the most recent (latest) activity initiated at the top of stack. Based on the orientation change performed on the second application icon, the activity recorder module 114 and the orientation identifier module 202 is configured to associate one or more activities with the identified orientation change and execute one or more activities to the second application icon. The recent activity is always present at the top of stack.

Consider an example where an activity 1 corresponds to playing a song from a pre-defined playlist in a music player application (application 1), an activity 2 corresponds to rejecting incoming calls in the phone application (application 2) and an activity 3 corresponds to displaying received emails in inbox of the email application icon (application 3). The user selects the three activities described above by performing orientation changes in the respective application icons.

When a user makes an orientation change for activity 1, a method corresponding to playing a song from a pre-defined playlist in a music player application (application 1) is initiated. When the user initiates another activity 2 by changing the orientation of the phone application (application 2), a second method corresponding to rejecting incoming calls is initiated in the phone application (application 2). The orientation identifier module 202 is configured to identify the orientation change and the activity recorder module 114 is configured to record the activity being initiated. The activity 2 of application 2 related to rejecting incoming calls is pushed to the top of the stack and the activity 1 of application 1 related to playing a song from a pre-defined playlist in a music player application the song is moved to a pause state. When the user initiates an activity 3 of application 3 related to displaying received emails in the inbox of the email application icon (application 3). The activity 3 is at the top of the stock, followed by activity 2 and activity 1. Activity 3 is executed first, followed by activity 2 and activity 1. As soon as activity 3 is performed and completed, activity 2 is pushed to the top of stack and executed. Once activity 3 (application 3) related to displaying emails is executed, the activity 2 related to rejecting incoming calls is pushed to top of the stack and executed. Once activity 2 is executed, activity 1 related to music player (application 1) comes to the top of the stack and the music player starts playing the song. In an embodiment, the user can destroy all the activities related to any of the application 1, 2 or 3 by executing the back operation. All the activities initiated by the user are disabled and the second application icon converts back to first application icon.

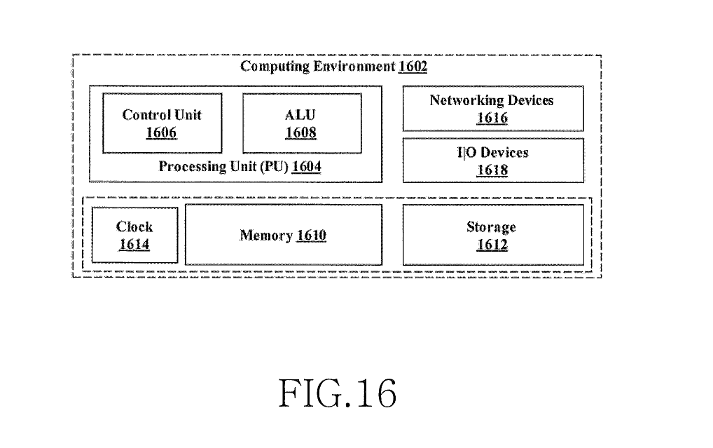

FIG. 16 illustrates a computing environment implementing the method of interacting with an application icon in an electronic device, in accordance with various embodiments of the present disclosure. As depicted, the computing environment 1602 comprises at least one processing unit 1604 that is equipped with a control unit 1606 and an Arithmetic Logic Unit (ALU) 1608, a memory 1610, a storage unit 1612, a clock chip 1614, plurality of networking devices 1616, and a plurality Input output (I/O) devices 1618. The processing unit 1604 is responsible for processing the instructions of the algorithm. The processing unit 1604 receives commands from the control unit 1606 in order to perform its processing. Further, any logical and arithmetic operations involved in the execution of the instructions are computed with the help of the ALU 1608.

The overall computing environment 1602 can be composed of multiple homogeneous and/or heterogeneous cores, multiple CPUs of different kinds, special media and other accelerators. The processing unit 1604 is responsible for processing the instructions of the algorithm. The processing unit 1604 receives commands from the control unit 1606 in order to perform its processing. Further, any logical and arithmetic operations involved in the execution of the instructions are computed with the help of the ALU 1608. Further, the plurality of process units may be located on a single chip or over multiple chips.

The algorithm comprising of instructions and codes used for the implementation are stored in either the memory unit 1610 or the storage 1612 or both. At the time of execution, the instructions may be fetched from the corresponding memory 1610 and/or storage 1612, and executed by the processing unit 1604. The processing unit 1604 synchronizes the operations and executes the instructions based on the timing signals generated by the clock chip 1614. The embodiments disclosed herein can be implemented through at least one software program running on at least one hardware device and performing network management functions to control the elements. The elements shown in the FIGS. 1-16 include various units, blocks, modules, or steps described in relation with methods, processes, algorithms, or systems of the present disclosure, which can be implemented using any general purpose processor and any combination of programming language, application, and embedded processor.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of one or more embodiments, those skilled in the art will recognize that the embodiments herein can be practiced with modification within the spirit and scope of the embodiments as described herein.

What is claimed is:

1. A method for interacting with at least one application icon in an electronic device, said method comprising:
identifying an interaction performed on a displayed at least one first application icon by a user;
associating at least one activity with said identified interaction on said displayed at least one first application icon; and
executing said at least one activity associated with said identified interaction.

2. The method of claim 1, wherein said interaction comprises an orientation change.

3. The method of claim 1, wherein said method further comprises:
converting said first application icon to at least one second application icon based on an identified said orientation change;
displaying said at least one second application icon in accordance to said at least one activity;
executing said at least one activity associated with said identified orientation change of said at least one second application icon.

4. The method of claim 3, wherein said method further comprises deactivating said at least one activity associated with said displayed at least one second application icon based on one of said orientation change and at least one action.

5. The method of claim 3, wherein said method further comprises executing recently said executed at least one activity associated with said orientation change of said at least one second application icon.

6. A system for interacting with at least one application icon in an electronic device, wherein said electronic device comprises a controller, the configured to:
identify an interaction performed on a displayed at least one first application icon by a user;
associate at least one activity with said identified interaction on said displayed at least one first application icon; and
execute said at least one activity associated with said identified interaction.

7. The system as in claim 6, wherein said interaction comprises an orientation change.

8. The system of claim 6, wherein said system is further configured to:
convert said first application icon to at least one second application icon based on an identified orientation change;
display said at least one second application icon in accordance to said at least one activity; and
execute said at least one activity associated with said identified orientation change of said at least one second application icon.

9. The system of claim 8, wherein said system is further configured to deactivate said at least one activity associated with said displayed at least one second application icon based on one of said orientation and at least one action.

10. The system of claim 8, wherein said system is further configured to execute recently said executed at least one activity associated with said orientation change of said at least one second application icon.

11. A apparatus for interacting with at least one application icon in an electronic device, the apparatus comprising:
an integrated circuit comprising at least one processor;
at least one memory having a computer program code within said circuit, wherein said at least one memory and said computer program code with said at least one processor cause said apparatus to:
identify an interaction performed on a displayed at least one first application icon by a user;
associate at least one activity with said identified interaction on said displayed at least one first application icon; and
execute said at least one activity associated with said identified interaction.

12. The apparatus of claim 11, wherein said interaction comprises an orientation change.

13. The apparatus of claim 11, wherein said product is further configured to:
convert said first application icon to at least one second application icon based on an identified orientation change;
display said at least one second application icon in accordance to said at least one activity; and
execute said at least one activity associated with said identified orientation change of said at least one second application icon.

14. The apparatus of claim 13, wherein said product is further configured to deactivate said at least one activity associated with said displayed at least one second application icon based on one of said orientation and at least one action.

15. The apparatus of claim 13, wherein said product is further configured to execute recently said executed at least one activity associated with said orientation change of said at least one second application icon.

16. A non-transitory machine-readable medium carrying one or more instructions which, when executed by one or more processors, cause the one or more processors to:
identify an interaction performed on a displayed at least one first application icon by a user;
associate at least one activity with said identified interaction on said displayed at least one first application icon; and
execute said at least one activity associated with said identified interaction.

17. The non-transitory machine-readable medium as in claim 16, wherein said interaction comprises an orientation change.

18. The non-transitory machine-readable medium of claim 16, wherein said one or more instructions further cause the processors to:
convert said first application icon to at least one second application icon based on an identified orientation change;
display said at least one second application icon in accordance to said at least one activity; and
execute said at least one activity associated with said identified orientation change of said at least one second application icon.

19. The non-transitory machine-readable medium of claim 18, wherein said one or more instructions further cause the processors to deactivate said at least one activity associated with said displayed at least one second application icon based on one of said orientation and at least one action.

20. The non-transitory machine-readable medium of claim 18, wherein said one or more instructions further cause the processors to execute recently said executed at least one activity associated with said orientation change of said at least one second application icon.
